(19) United States
(12) Patent Application Publication
(10) Pub. No.: US 2022/0385726 A1
(43) Pub. Date: Dec. 1, 2022

(54) INFORMATION PROCESSING APPARATUS, COMPUTER-READABLE RECORDING MEDIUM STORING PROGRAM, AND INFORMATION PROCESSING METHOD

(71) Applicant: FUJITSU LIMITED, Kawasaki-shi (JP)

(72) Inventor: Munenori MAEDA, Yokohama (JP)

(73) Assignee: FUJITSU LIMITED, Kawasaki-shi (JP)

(21) Appl. No.: 17/592,902

(22) Filed: Feb. 4, 2022

(30) Foreign Application Priority Data
May 25, 2021 (JP) 2021-087751

(51) Int. Cl. H04L 67/1042; H04L 67/289; H04L 41/0866; H04L 43/10

(52) U.S. Cl. CPC H04L 67/1051; H04L 67/289; H04L 41/0866; H04L 43/10

(57) ABSTRACT

An information processing apparatus including: a memory; and a processor coupled to the memory, the processor being configured to: in a network coupling a plurality of storage nodes, at least one proxy, and at least one client; collect information of accesses executed most by the at least one client via the at least one proxy on a path of each access; based on the information of accesses, calculate network distances between the plurality of storage nodes and the at least one proxy; and based on the network distances, determine a leader to be one of the plurality of storage nodes that is close to one of the at least one proxy accessed most frequently.

### CROSS-REFERENCE TO RELATED APPLICATION

This application is based upon and claims the benefit of priority of the prior Japanese Patent Application No. 2021-87751, filed on May 25, 2021, the entire contents of which are incorporated herein by reference.

### FIELD

The embodiment discussed herein is related to an information processing apparatus, a computer-readable recording medium storing a program, and an information processing method.

### BACKGROUND

In the cloud, serverless computing may be used. In serverless computing, beyond the frame of the usual cloud computing, such as hosting services or the like, processing units called functions freely operate regardless of hardware resources. The cloud thereby thoroughly uses the hardware. Users are charged pay-per-use, based on the number of requests for functions and are facilitated to start small.

Serverless computing may have difficulties in handling of data intended to be persistent. It is basically impossible to specify where functions are to operate, and usual serverless computing generally uses public cloud storage services accessible from anywhere in the world. Public cloud storages are excellent in durability and availability. However, some inexpensive storages have long response time (for example, latency), or the cloud databases (DBs) are expensive and do not allow for immediate scaling up.

As a storage of persistent data for serverless computing, a distributed data store has been introduced in recent years. The distributed data store implements DB functions (atomicity, consistency, isolation, and durability=ACID) in a computing environment spread in a wide area, such as multi-cloud or multi-cluster environments.

A basic distributed data store is composed of N (N>2) servers. Each server is individually placed in one of separate sites (data centers, for example). Even if some of the servers or networks have failed, services may be continued by the remaining servers. In a distributed data store for serverless computing, the place where a function is executed varies, and the configuration (server placement sites, for example) of the distributed data store is changed so as to shorten the response time from the place where the function is executed.

Examples of the related art include as follows: U.S. Patent Application Publication No. 2016/0098225, Japanese Laid-open Patent Publication No. 2009-151403, and International Publication Pamphlet No. WO 2014/188682.

### SUMMARY

According to an aspect of the embodiments, there is provided an information processing apparatus including: a memory; and a processor coupled to the memory, the processor being configured to: in a network coupling a plurality of storage nodes, at least one proxy, and at least one client; collect information of accesses executed most by the at least one client via the at least one proxy on a path of each access; based on the information of accesses, calculate network distances between the plurality of storage nodes and the at least one proxy; and based on the network distances, determine a leader to be one of the plurality of storage nodes that is close to one of the at least one proxy accessed most frequently.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram schematically illustrating a hardware configuration example of a computer apparatus according to an embodiment;

FIG. 2 is a block diagram schematically illustrating a configuration example of a distributed data store system according to the embodiment;

FIG. 3 briefly illustrates the configuration example of the distributed data store system illustrated in FIG. 2;

FIG. 4 is a table exemplarily illustrating round-trip times among S parameters in the distributed data store system illustrated in FIG. 3;

FIG. 5 is a table exemplarily illustrating upload bandwidths among the S parameters in the distributed data store system illustrated in FIG. 3;

FIG. 6 is a table exemplarily illustrating download bandwidths among the S parameters in the distributed data store system illustrated in FIG. 3,

FIG. 7 is a table exemplarily illustrating message rates among the S parameters in the distributed data store system illustrated in FIG. 3;

FIG. 8 is a table exemplarily illustrating upstream and downstream bandwidths among the S parameters in the distributed data store system illustrated in FIG. 3;

FIG. 9 is a table illustrating download (downstream) bandwidths among D parameters in the distributed data store system illustrated in FIG. 3;

FIG. 10 is a table illustrating transferred data volume among the D parameters in the distributed data store system illustrated in FIG. 3;

FIG. 11 is a table for determining a leader node in the distributed data store system illustrated in FIG. 3;

FIG. 12 is a table for determining the configuration of storage nodes in the distributed data store system illustrated in FIG. 3;

FIG. 13 is a table for calculating network distances in the distributed data store system illustrated in FIG. 3;

FIG. 14 is a flowchart for explaining a first example of a performance monitoring process by a client side in the embodiment;

FIG. 15 is a flowchart for explaining a first example of a leader reassignment process by a management apparatus in the embodiment;

FIG. 16 is a flowchart for explaining a first example of a leader reassignment process by a storage node in the embodiment;

FIG. 17 is a flowchart for explaining a second example of the leader reassignment process by the storage node in the embodiment;

FIG. 18 is a flowchart for explaining a second example of the performance monitoring process by the client side in the embodiment; and

FIG. 19 is a flowchart for explaining a second example of the leader reassignment process by the management apparatus in the embodiment.

### DESCRIPTION OF EMBODIMENTS

In distributed data stores, the configuration may be changed. However, during change of the configuration, the plurality of servers may assign themselves to serve as a leader, which could result in a situation called sprit brain, where DB consistency is broken. In order to avoid sprit brain, it is conceivable that the configuration is changed while services are suspended. However, suspension of services may cause an issue of availability. By using a consensus algorithm, it is possible to simultaneously avoid sprit brain and implement the availability. However, the leader is basically determined in elections among servers and is not guaranteed to be located near the place where the function is executed.

In one aspect, an object is to improve the performance of a distributed data store.

### [A] Embodiment

An embodiment will be described below with reference to the drawings. The embodiment described below is merely illustrative and is not intended to exclude employment of various modification examples or techniques that are not explicitly described in the embodiment. For example, the present embodiment may be implemented by variously modifying the embodiment without departing from the gist of the embodiment. Each of the drawings is not intended to indicate that only the elements illustrated in the drawing are included. Thus, other functions or the like may be included.

Hereafter, each of the same reference signs denotes substantially the same portion in the drawings, so that the description thereof is omitted.

### [A-1] Configuration Example

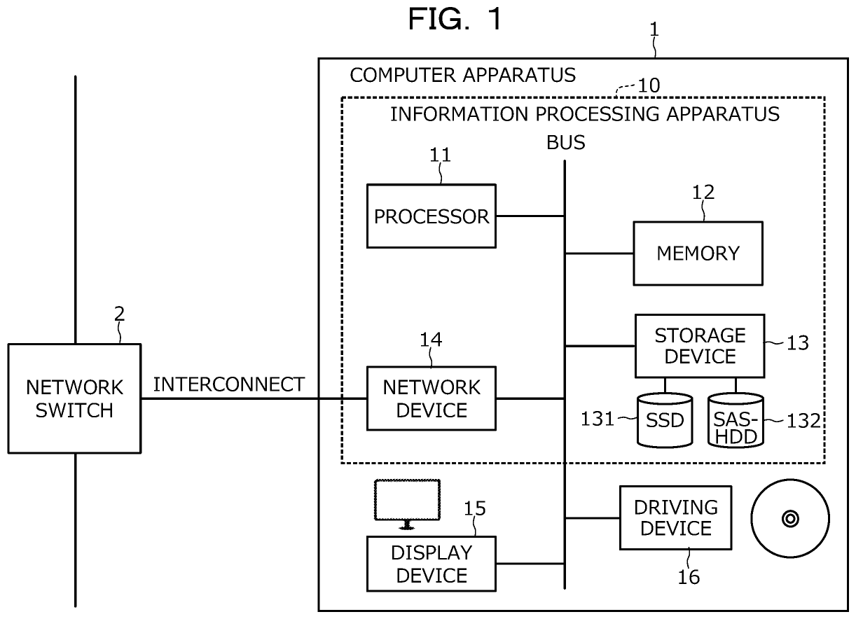

FIG. 1 is a block diagram schematically illustrating a hardware configuration example of a computer apparatus 1 according to the embodiment.

The computer apparatus 1 includes an information processing apparatus 10, a display device 15, and a driving device 16.

The information processing apparatus 10 includes processor 11, a memory 12, storage device 13, and a network device 14.

The processor 11 is a processing device that exemplarily performs various types of control and various operations. The processor 11 realizes various functions when an operating system (OS) and programs stored in the memory 12 are executed.

The programs to realize the functions of the processor 11 may be provided in a form in which the programs are recorded in a computer-readable recording medium such as, for example, a flexible disk, a compact disc (CD) (such as a CD-read-only memory (CD-ROM), a CD-recordable (CD-R), or a CD-rewritable (CD-RW)), a Digital Versatile Disc (DVD) (such as a DVD-ROM, a DVD-random-access memory DVD-RAM), a DVD-R, a DVD+R, a DVD-RW, a DVD+RW, or a High Definition (HD) DVD), a Blu-ray disk, a magnetic disk, an optical disc, or a magneto-optical disk. The computer (the processor 11 according to the present embodiment) may read the programs from the above-described recording medium through a reading device (not illustrated) and transfer and store the read programs to an internal recording device or an external recording device. The program may be recorded in a storage device (recording medium) such as, for example, the magnetic disk, the optical disc, or the magneto-optical disk and provided from the storage device to the computer via a communication path.

When the functions as the processor 11 are realized, the program stored in the internal storage device (the memory 12 in the present embodiment) may be executed by the computer (the processor 11 in the present embodiment). The computer may read and execute the program recorded in the recording medium.

The processor 11 controls operation of the entire information processing apparatus 10. The processor 11 may be a multiprocessor. The processor 11 may be any one of, for example, a central processing unit (CPU), a microprocessor unit (MPU), a digital signal processor (DSP), an application-specific integrated circuit (ASIC), a programmable logic device (PLD), and a field-programmable gate array (FPGA). The processor 11 may be a combination of two or more elements of the CPU, the MPU, the DSP, the ASIC, the PLD, and the FPGA.

The memory 12 is, for example, a storage device that includes a read-only memory (ROM) and a random-access memory (RAM). The RAM may be, for example, a dynamic RAM (DRAM). A program such as Basic Input/Output System (BIOS) may be written in the ROM of the memory 12. The software program in the memory 12 may be loaded and executed by the processor 11 as appropriate. The RAM of the memory 12 may be used as a primary recording memory or a working memory.

The storage device 13 is, for example, a device that stores data such that the data is able to be read from and written to the storage 13. The storage device 13 may be, for example, a solid-state drive (SSD) 131, a serial attached SCSI Hard disk drive (SAS-HDD) 132, or a storage class memory (SCM) (not illustrated).

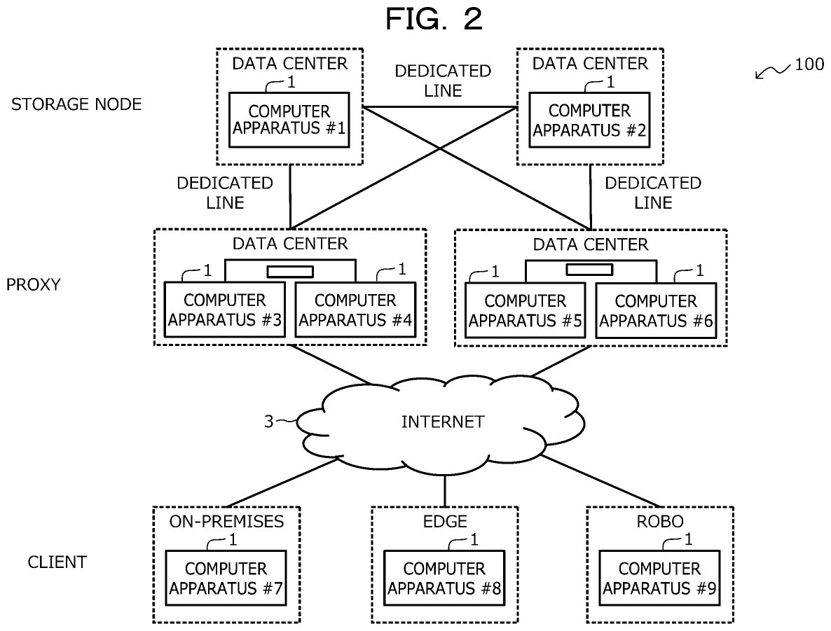

The network device 14 is an interface device which couples the information processing apparatus 10 to the network switch 2 via an interconnect for communication with a network, such as the Internet 3 (described later with reference to FIG. 2 and the like), via the network switch 2. As the network device 14, for example, various interface cards corresponding to the standard of the network such as wired local area network (LAN), wireless LAN, and wireless wide area network (WWAN) may be used.

The display device 15 is a liquid crystal display, an organic light-emitting diode (OLED) display, a cathode ray tube (CRT), an electronic paper display, or the like and displays various types of information for, for example, an operator.

The driving device 16 is configured so that a recording medium is removably inserted thereto. The driving device 16 is configured to be able to read information recorded on a recording medium in a state in which the recording medium is inserted thereto. In this example, the recording medium is portable. For example, the recording medium is the flexible disk, the optical disc, the magnetic disk, the magneto-optical disk, a semiconductor memory, or the like.

FIG. 2 is a block diagram schematically illustrating a configuration example of a distributed data store system 100 according to the embodiment.

The distributed data store system 100 includes a plurality of (in the example illustrated in FIG. 2, nine) computer apparatuses 1 (for example, computer apparatuses #1 to #9).

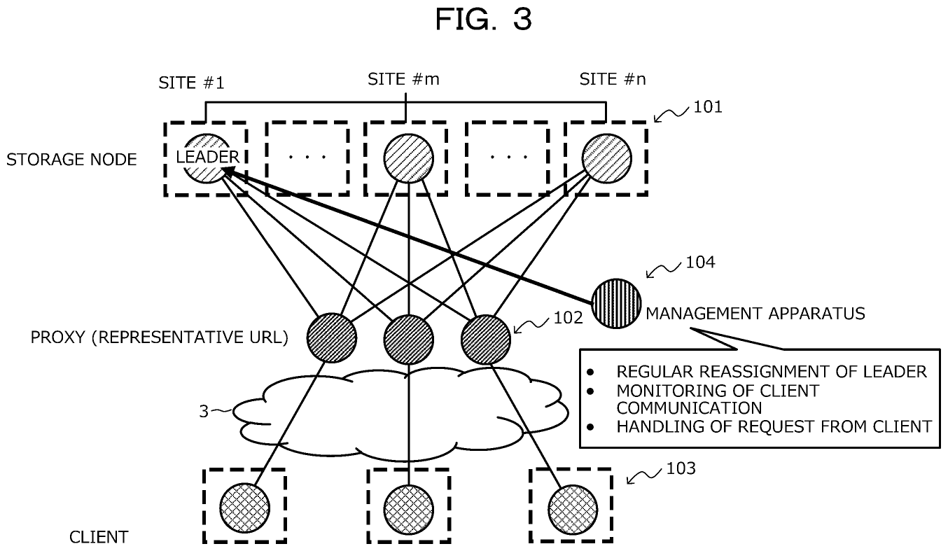

The computer apparatuses #1 and #2 may be respectively placed in different data centers and may each serve as a storage node 101 (described later with reference to FIG. 3 and the like). The computer apparatuses #3 and #4 may be placed in a same data center while the computer apparatuses #5 and #6 are also placed in a same data center, and the computer apparatuses #3 to #6 may each serve as a proxy 102 (described later with reference to FIG. 3 and the like). The computer apparatuses #7 to #9 may serve as clients 103 (described later with reference to FIG. 3 and the like). For example, the computer apparatus #7 may function as an on-premises server; the computer apparatus #8 may function as an edge; and the computer apparatus #9 may serve as Remote Office Branch Office (ROBO).

The computer apparatuses 1 as storage nodes are coupled to each other via dedicated lines, and the computer apparatuses 1 as the storage nodes and the computer apparatuses 1 as proxies are coupled via dedicated lines. The computer apparatuses 1 as the proxies and the computer apparatuses 1 as clients are coupled via the Internet 3. The Internet 3 may be replaced with a different type of network, such as wide area network (WAN).

FIG. 3 briefly illustrates the configuration example of the distributed data store system 100 illustrated in FIG. 2.

In the example illustrated in FIG. 3, n storage nodes 101 are respectively placed in a site #1, . . . , a site #m, . . . and a site #n. Each storage node 101 is coupled to the three proxies 102 (for example, representative Uniform Resource Locators (URLs)). Each of the proxies 102 is coupled to the three clients 103 via the Internet 3.

As illustrated in FIG. 3, the storage nodes 101 are coupled to a management apparatus 104. The management apparatus 104 regularly reassigns a leader (the storage node 101 in the site #1 in the example illustrated in FIG. 1) of the storage nodes 101, monitors clients' communications, and handles requests from the clients 103.

The storage nodes 101, proxies 102, and clients 103 may be located at different sites. The storage nodes 101, proxies 102, and clients 103 may be operated at a same site. In such a case, the storage nodes 101, proxies 102, and clients 103 are located in consideration of a fault domain. The fault domain refers to a hardware set sharing a single point of failure.

The proxies 102 include the plurality of proxies 102 and couple the clients 103 to the storage nodes 101 to relay communications therebetween. The proxies 102 are distributed in a wide area, and the URLs thereof are open to the clients 103. Each URL corresponds to at least one node. For the purpose of load sharing, each proxy 102 may be composed of the plurality of nodes within a same site. In this case, the URL is resolved to any one of the plurality of IP addresses with a DNS. Latencies and bandwidths to the storage nodes 101 are different between the proxies 102. Even in the case where each proxy 102 is composed of the plurality of nodes, the tendency (average values and the like) thereof does not exhibit a great difference. For each proxy 102, an access counter or upstream and downstream transferred data size is monitored, and the values thereof in the last period A may be acquired by accessing the proxy 102.

The clients 103 are distributed in a wide area, and round-trip times or upstream and downstream bandwidths between each client 103 and the respective proxies 102 are measured in advance. Each client 103 is then selectively coupled to the proxy 102 (URL, for example) that is close to the client 103 itself.

The function as the management apparatus 104 may be included in any one of the proxies 102 or the storage nodes 101. The management apparatus 104 may access both the proxies 102 and storage nodes 101 and may use multiple nodes based on majority voting using a Raft algorithm or a Paxos algorithm.

For starting election of a storage node 101 as a leader, the management apparatus 104 executes a leader reassignment process based on monitoring according to a service level agreement (SLA) of the clients 103 or regular execution.

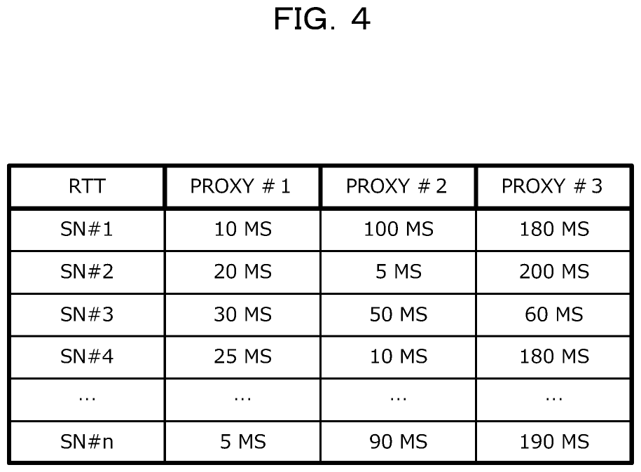

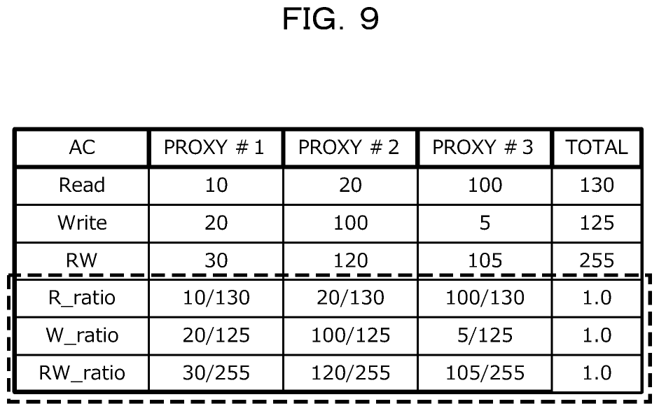

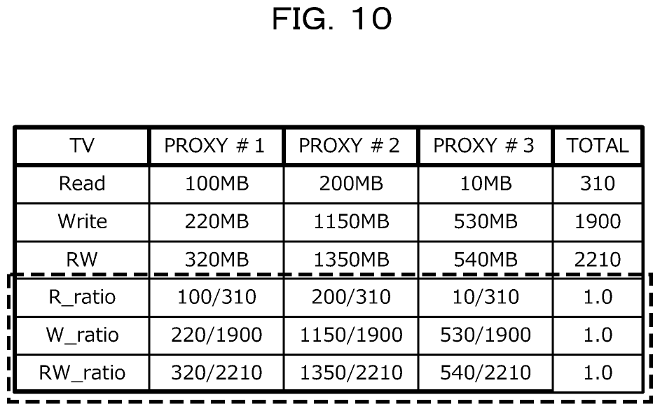

In the leader reassignment process, the management apparatus 104 acquires S parameters (later described using FIGS. 4 to 8 and the like) and acquires D parameters (later described using FIGS. 9 and 10 and the like). Next, the management apparatus 104 calculates network (NW) distances to acquire Leader_new and sends TriggerElection RPC to the leader that the management apparatus 104 knows. TriggerElection RPC includes information of Leader_new as data.

The storage node 101 having received TriggerElection RPC replies approval=ACK (true) if being the leader. On the other hand, if not being the leader, the storage node 101 having received TriggerElection RPC replies denial=NACK (false) and leader information that the storage node 101 itself knows.

When receiving the denial replied from the storage node 101, the management apparatus 104 sets the leader that the management apparatus 104 knows to the leader included in the replied data and again sends TriggerElection RPC to the storage node 101 included in the replied data.

The storage node 101 as the leader having received TriggerElection RPC suspends transmission of heartbeats (AppendEntry RPC) to a follower as Leader_new during a timeout period for heartbeat reception plus a margin. If not receiving AppendEntry RPC during the timeout period, the storage node 101 autonomously runs for leader.

AppendEntry RPC is one of RPCs used in the Raft algorithm and is a heartbeat message from the leader to followers as well as a message for data replication.

The leader reassignment process may be also executed by the following method.

Each storage node 101 starts the leader reassignment process regularly using a timer.

Each storage node 101 terminates the process if the storage node 101 itself is the leader or the node state thereof is Candidate.

On the other hand, each storage node 101 acquires S parameters and acquires D parameters if the storage node 101 is not the leader and the node state thereof is not Candidate. Next, each storage node 101 calculates NW distances and calculates Leader_new. Each storage node 101 changes the node state to Candidate if the storage node 101 is not Leader_new. This is because the storage node 101 of interest is a follower and a candidate node. Hereinafter, the same process as that of the aforementioned leader election through the Raft algorithm is executed. For example, RequestVote RPC is sent to all the storage nodes 101. If a majority of the storage nodes 101 approves, a new leader is elected.

RequestVote RPC is one of RPCs used in the Raft algorithm and is a message through which RPC sender node s asks a receiver node r to vote for the sender node s in leader election.

The management apparatus 104 may function as a configuration management server that changes site assignment of each storage node 101. The function as the configuration management server may be assigned to any storage node 101. The configuration management server may access both the proxies 102 and the storage nodes 101. To enhance the reliability, the configuration management server may use multiple nodes based on majority voting using the Raft algorithm or Paxos algorithm.

For serving as the configuration management server, the management apparatus 104 executes the following change of site assignment based on monitoring according to the service level agreement (SLA) of the clients 103 or based on regular execution.

The management apparatus 104 acquires the S parameters and acquires the D parameters. Next, the management apparatus 104 calculates the NW distances and determines a set of storage nodes and Leader_new. If the set of storage nodes is the same as the current set of storage nodes, the change of site assignment is unnecessary and is terminated. If Leader_new is different from the current leader, the aforementioned leader reassignment process is executed.

The management apparatus 104 executes a joint consensus procedure of the Raft algorithm. For example, where the old set of storage nodes (before the change) is C1, the new set of storage nodes (after the change) is C2, and the union of the old and new sets of storage nodes is C1 U C2, the set of storage nodes transits from C1 to C2 configuration via the C1 U C2 configuration. After the change to the new configuration, the management apparatus 104 executes the leader reassignment process to choose Leader_new.

For example, the information processing apparatus 10 collects information of accesses executed most by at least one client 103 via at least one proxy 102 on a path of each access. Based on the information of accesses, the information processing apparatus 10 calculates the network distances between the plurality of storage nodes 101 and the at least one proxy 102. Based on the network distances, the information processing apparatus 10 determines the leader to be one of the plurality of storage nodes 101 that is close to the proxy 102 accessed most frequently.

The information of accesses may include static parameters and dynamic parameters between the plurality of storage nodes 101 and the at least one proxy 102 for calculating the network distances.

The information processing apparatus 10 may determine the leader when any client 103 determines that an access performance value does not meet a request. The information processing apparatus 10 may determine the leader when any client 103 determines that a request for site change of the plurality of storage nodes 101 is met.

FIG. 4 is a table exemplarily illustrating round-trip times (RTT) among the S parameters in the distributed data store system 100 illustrated in FIG. 3.

The S parameters are substantially static parameters. The S parameters may be acquired through measurement in advance or may be acquired through measurement as appropriate. The S parameters are parameters which are not completely constant and are re-measured much less frequently than the D parameters described later.

In the round-trip times illustrated in FIG. 4, round-trip times from each storage node 101 (SN #1 to #n) to the respective proxies 102 (proxy #1 to #3) are registered.

At SN #1, for example, the round-trip time to the proxy #1 is 10 ms; the round-trip time to the proxy #2 is 100 ms; and the round-trip time to the proxy #3 is 180 ms.

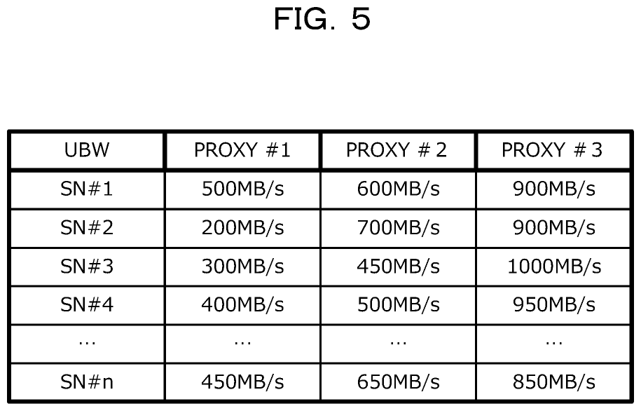

FIG. 5 is a table exemplarily illustrating upload (upstream) bandwidths among the S parameters in the distributed data store system 100 illustrated in FIG. 3.

In the upload bandwidths illustrated in FIG. 5, upload bandwidths from each proxy 102 (proxy #1 to #3) to the respective storage nodes 101 (SN #1 to #n) are registered.

At SN #1, for example, the upload bandwidth from the proxy #1 is 500 MB/s; the upload bandwidth from the proxy #2 is 600 MB/s; and the upload bandwidth from the proxy #3 is 900 MB/s.

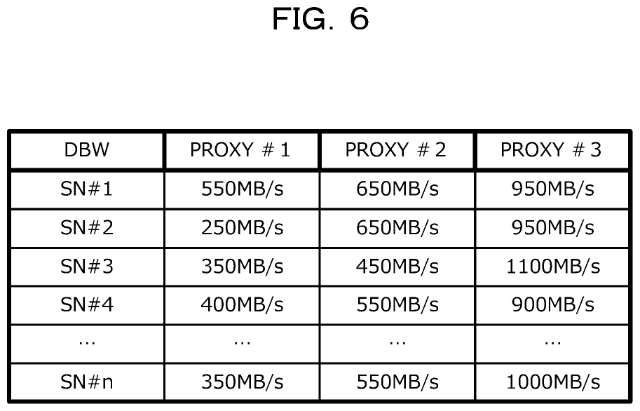

FIG. 6 is a table exemplarily illustrating download (downstream) bandwidths among the S parameters in the distributed data store system 100 illustrated in FIG. 3.

In the download bandwidths illustrated in FIG. 6, download bandwidths from each storage node 101 (SN #1 to #n) to the respective proxies 102 (proxy #1 to #3) are registered.

At SN #1, for example, the download bandwidth to the proxy #1 is 550 MB/s; the download bandwidth to the proxy #2 is 650 MB/s; and the download bandwidth to the proxy #3 is 950 MB/s.

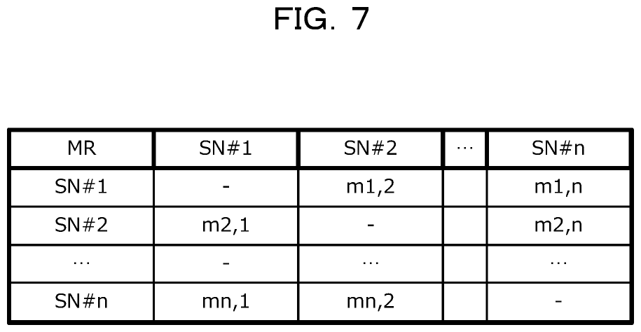

FIG. 7 is a table exemplarily illustrating message rates (MRs) among the S parameters in the distributed data store system 100 illustrated in FIG. 3.

In the message rates illustrated in FIG. 7, message rates indicating how many messages of a fixed length are able to be handled per second between the storage nodes 101 (SN #1 to #n).

At SN #1, for example, the message rate to SN #2 is m1,2, and the message rate to SN #n is m1,n.

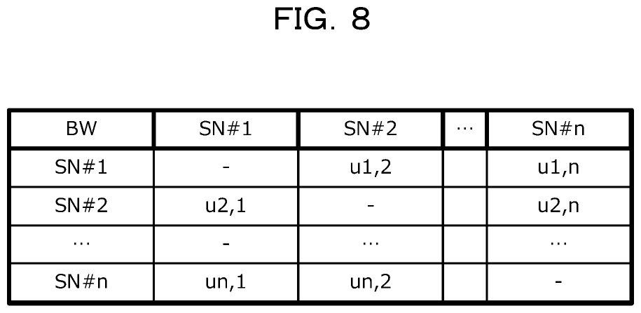

FIG. 8 is a table exemplarily illustrating upstream and downstream bandwidths among the S parameters in the distributed data store system 100 illustrated in FIG. 3.

In the upstream and downstream bandwidths illustrated in FIG. 8, the upstream and downstream bandwidths between the storage nodes 101 (SN #1 to #n) are registered.

At SN #1, for example, the upstream and downstream bandwidth to SN #2 is u1,2, and the upstream and downstream bandwidth to SN #n is u1,n.

FIG. 9 is a table illustrating download (downstream) bandwidths among the D parameters in the distributed data store system 100 illustrated in FIG. 3.

The D parameters are dynamically changing parameters.

In the download bandwidths illustrated in FIG. 9, read ratios (R_ratio), write ratios (W_ratio), and read and write ratios (RW_ratio) at the respective proxies 102 (proxy #1 to #3) are registered.

In the example illustrated in FIG. 9, for example, the number of reads for the proxy #1 is 10; the number of writes is 20; and the number of reads and writes is 30. The total number of reads for the proxies #1 to #3 is 130; the total number of writes is 125; and the total number of reads and writes is 255. For the proxy #1, therefore, R_ratio=10/130, W_ratio=20/125, and RW_ratio=30/255 are calculated.

FIG. 10 is a table illustrating transferred data volume among the D parameters in the distributed data store system 100 illustrated in FIG. 3.

In the transferred data volume illustrated in FIG. 10, read ratios (R_ratio), write ratios (W_ratio), and read and write ratios (RW_ratio) in a period A at the respective proxies 102 (proxy #1 to #3) are registered.

In the example illustrated in FIG. 10, for example, the volume of Read data for the proxy #1 is 100 MB; the volume of Write data is 220 MB; and the volume of RW (Read and Write) data is 320 MB. The total volume of Read data for the proxies #1 to #3 is 310 MB; the total volume of Write data is 1900 MB; and the total volume of RW data is 2210 MB. For the proxy #1, therefore, R_ratio=100/310, W_ratio=220/1900, and RW_ratio=320/2210 are calculated.

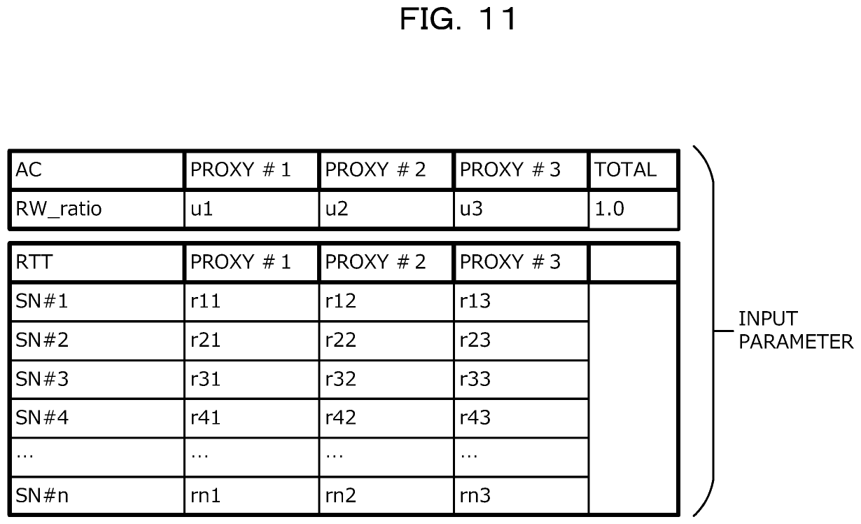

FIG. 11 is a table for determining the leader node in the distributed data store system 100 illustrated in FIG. 3.

By calculating the network distances, the leader node may be determined based on the condition of accesses to the proxies 102 when the sites of the storage nodes 101 are fixed, and the configuration of the storage nodes 101 may be determined based on the current network congestion and the condition of accesses to the proxies 102.

The leader node may be calculated based on RW_ratio of the download bandwidths illustrated in FIG. 9 and the round-trip times illustrated in FIG. 4, for example. For example, average RTT of RW requests from all the clients 103 are calculated for each storage node 101 by using RTT of the S parameters and RW_ratio of the D parameters.

As illustrated in FIG. 11, when RW_ratio at proxy #P is uP and RTT between SN #Q and proxy #P is rQP, the next leader node may be determined to be a storage node exhibiting one of C1, C2, and C3 below that is larger than 0 and is the smallest.

c1=r11*u1+r12*u2+r13*u3

c2=r21*u1+r22*u2+r23*u3

c3=r31*u1+r32*u2+r33*u3

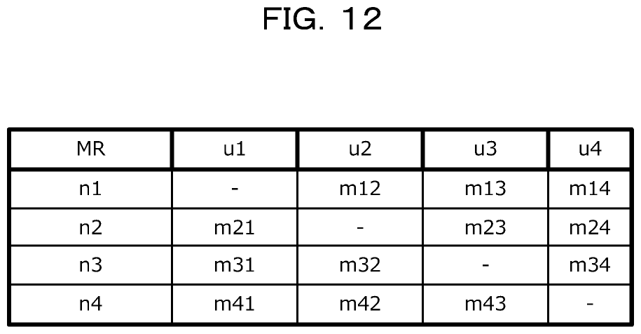

FIG. 12 is a table for determining the configuration of the storage nodes 101 in the distributed data store system 100 illustrated in FIG. 3.

For reflecting the network congestion, the S parameters may be measured just before determination of the configuration. The assignment and distances may be determined each for three sites, four sites, . . . , and N sites.

Hereinbelow, the case of selecting three sites in total (N=4) will be described.

The storage nodes 101 include four SN #1 to #4, and the number of ways of selecting three sites therefrom is four, including (1, 2, 3), (1, 2, 4), (1, 3, 4), and (2, 3, 4).

For (1, 2, 3), when the leader is SN #1, the time taken to transmit T replica messages is (T/m12+T/m13). When T is 1, f1=(1/m12+1/m13) is calculated in the table illustrated in FIG. 12. The network distance to the proxies 102 is calculated as c1=r11*u1+r12*u2+r13*u3. FIG. 12 corresponds to the table illustrating the message rates illustrated in FIG. 7.

When the leader is SN #2, f2=(1/m21+1/m23) is calculated in the table illustrated in FIG. 12, and the network distance c2 to the proxies 102 is calculated as c2=r21*u1+r22*u2+r23*u3.

When the leader is SN #3, the network distance c3 is calculated in a similar manner.

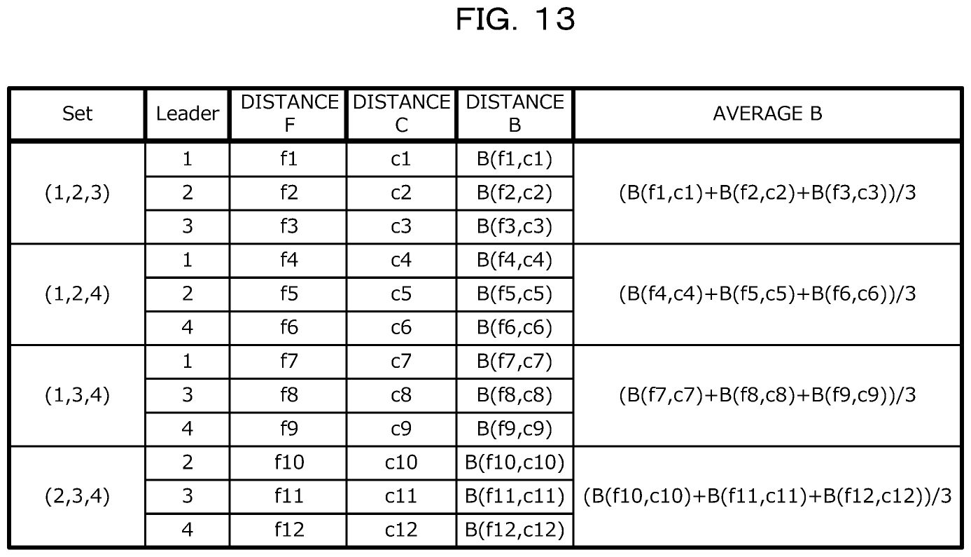

FIG. 13 is table for calculating the network distances in the distributed data store system 100 illustrated in FIG. 3.

In FIG. 13, a function B (distance B) adds up the distance F and distance C, as parameters, individually weighted with proper constants.

The weighting in the function B may be implemented as B(x, y)=a0*x+a1*y+a2*x*x+a3*y*y+a4*x*y by using polynomial regression, for example. Average B indicates the average value of the function B for a same set of sites.

In the case of four or more sites, the average B is greater than that in the case of three sites, but the reliability is higher. Application of weighting including the reliability therefore provides a combination of sites with the distance (the pair of the average B and reliability) minimized. This combination is the answer for site assignment.

### [A-2] Operation Example

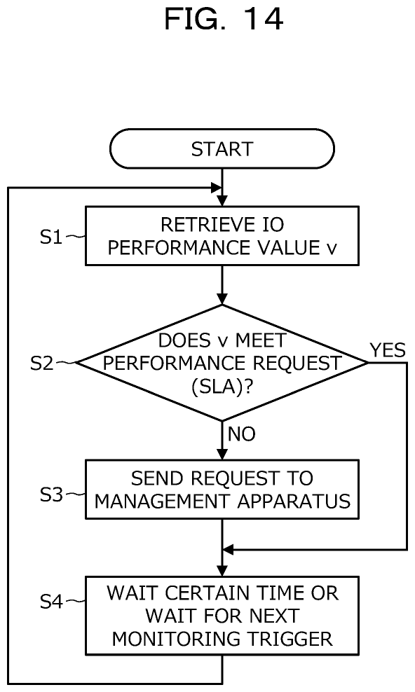

A first example of the performance monitoring process by the clients 103 side in the embodiment will be described according to the flowchart (steps S1 to S4) illustrated in FIG. 14.

The performance monitoring process is performed by each client 103 itself or an agent. The agent is an independent process that exists and operates on the same server as the client 103.

The performance monitoring process may be started at regular intervals (once per 1 minute or so on) or may be triggered by degradation of any performance index (response time or the like) of the client 103. If the performance value does not meet the performance request, a leader reassignment request may be sent to the management apparatus 104.

The client 103 retrieves an IO performance value v (step S1).

The client 103 determines whether the IO performance value v meets the performance request (SLA) (step S2).

If the IO performance value v meets the performance request (see YES route in step S2), the process proceeds to step S4.

If the IO performance value v does not meet the performance request (see NO route in step S2), the client 103 sends a leader reassignment request to the management apparatus 104 (step S3).

The client 103 waits a certain period of time or waits for the next monitoring trigger (step S4), and the process returns to step S1.

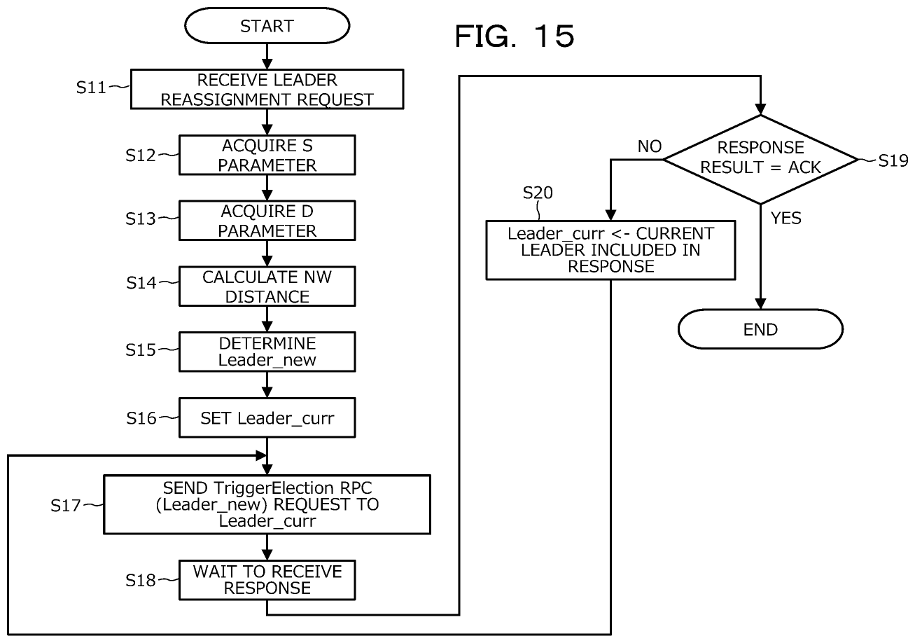

Next, a first example of the leader reassignment process by the management apparatus 104 in the embodiment will be described according to the flowchart (steps S11 to S20) illustrated in FIG. 15.

The management apparatus 104 receives a leader reassignment request from any client 103 (step S11).

The management apparatus 104 acquires the S parameters (step S12).

The management apparatus 104 acquires the D parameters (step S13).

The management apparatus 104 calculates the network (NW) distances based on the acquired S and D parameters (step S14).

The management apparatus 104 determines a new leader node, Leader_new, based on the calculated network distances (step S15).

The management apparatus 104 sets Leader_curr to a current leader node (step S16).

The management apparatus 104 sends TriggerElection RPC indicating Leader_new to the storage node 101 set as Leader_curr (step S17).

The management apparatus 104 waits to receive a response from the storage node 101 as Leader_curr (step S18).

The management apparatus 104 determines whether the response result=ACK (step S19).

If the response result is ACK (see YES route in step S19), the leader reassignment process is terminated.

If the response result is not ACK (see NO route in step S19), the management apparatus 104 sets Leader_curr to the current leader node included in the response result (step S20), and the process returns to step S17.

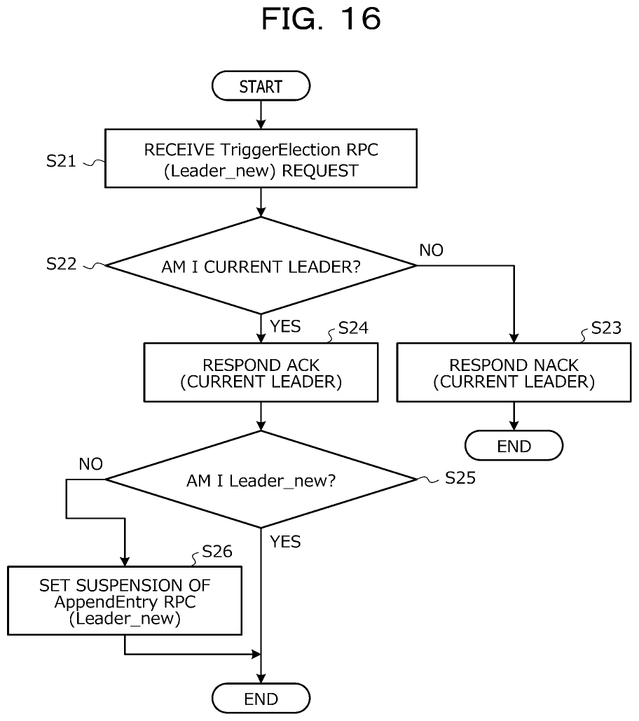

Next, a first example of the leader reassignment process by each storage node 101 in the embodiment will be described according to the flowchart (steps S21 to S26) illustrated in FIG. 16.

The storage node 101 receives a TriggerElection RPC request indicating Leader_new from the management apparatus 104 (step S21).

The storage node 101 determines whether the storage node 101 itself is the current leader node (step S22).

If the storage node 101 is not the current leader node (see NO route in step S22), the storage node 101 responds NACK and information indicating the current leader to the management apparatus 104 (step S23). The leader reassignment process is terminated.

If the storage node 101 is the current leader node (see YES route in step S22), the storage node 101 responds ACK and information indicating the current leader to the management apparatus 104 (step S24).

The storage node 101 determines whether the storage node 101 itself is Leader_new (step S25).

If the storage node 101 itself is Leader_new (see YES route in step S25), the leader reassignment process is terminated.

If the storage node 101 itself is not Leader_new (see NO route in step S25), the storage node 101 makes a setting to suspend AppendEntry RPC to Leader_new (step S26). The leader reassignment process is terminated.

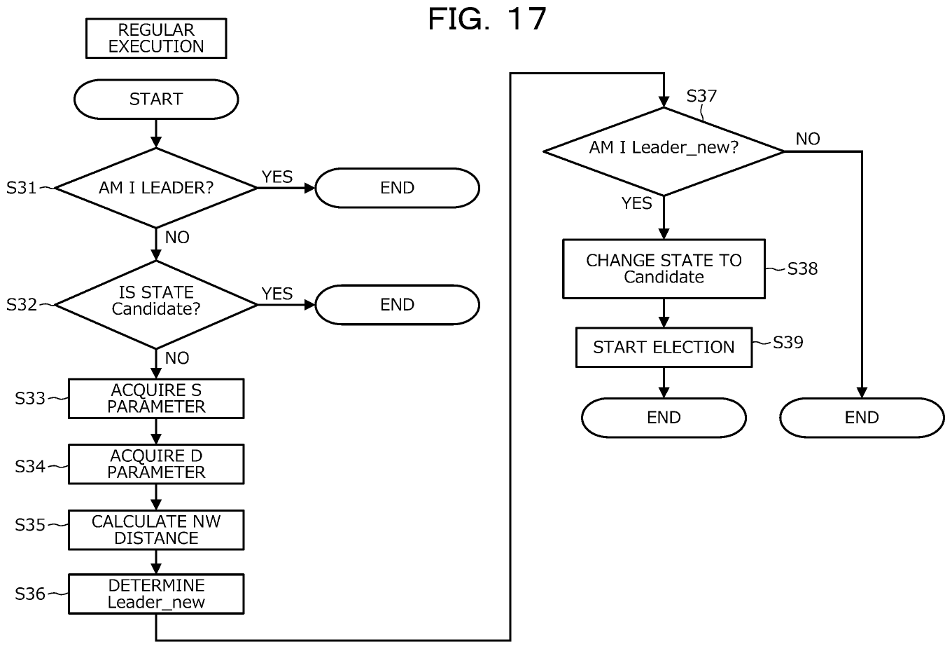

Next, a second example of the leader reassignment process by each storage node 101 in the embodiment will be described according to the flowchart (steps S31 to S39) illustrated in FIG. 17.

The storage node 101 determines whether the storage node 101 itself is the leader node (step S31).

If the storage node 101 itself is the leader node (see YES route in step S31), the leader reassignment process is terminated.

If the storage node 101 itself is not the leader node (see NO route in step S31), the storage node 101 determines whether the state thereof is Candidate (step S32).

If the state is Candidate (see YES route in step S32), the leader reassignment process is terminated.

If the state is not Candidate (see NO route in step S32), the storage node 101 acquires the S parameters (step S33).

The storage node 101 acquires the D parameters (step S34).

The storage node 101 calculates the network (NW) distances based on the acquired S and D parameters (step S35).

The storage node 101 determines a new leader node, Leader_new, based on the calculated network distances (step S36).

The storage node 101 determines whether the storage node 101 itself is Leader_new (step S37).

If the storage node 101 is not Leader_new (see NO route in step S37), the leader reassignment process is terminated.

If the storage node 101 is Leader_new (see YES route in step S37), the storage node 101 changes its state to Candidate (step S38).

The storage node 101 starts leader node election by each storage nodes 101 (step S39). The leader reassignment process is terminated.

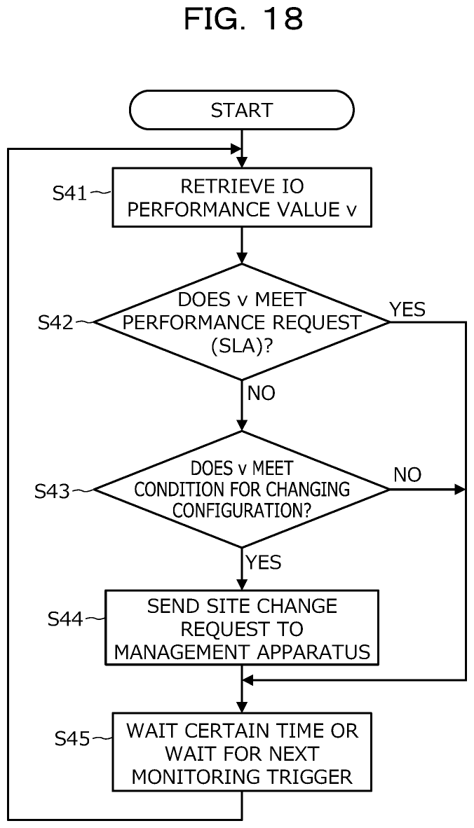

Next, the performance monitoring process for a site change request by the clients 103 side in the embodiment will be described according to the flowchart (steps S41 to S45) illustrated in FIG. 18.

Each client 103 retrieves the IO performance value v (step S41).

The client 103 determines whether the IO performance value v meets the performance request (SLA) (step S42).

When the IO performance value v meets the performance request (see YES route in step S42), the process proceeds to step S45.

If the IO performance value v does not meet the performance request (see NO route in step S42), the client 103 determines whether the IO performance value v meets the condition for changing the configuration (step S43).

If the IO performance value v does not meet the condition for changing the configuration (see NO route in step S43), the process proceeds to step S45.

If the IO performance value v meets the condition for changing the configuration (see YES route in step S43), the client 103 sends a site change request to the management apparatus 104 (step S44).

The client 103 waits a certain period of time or waits for the next monitoring trigger (step S45), and the process returns to step S41.

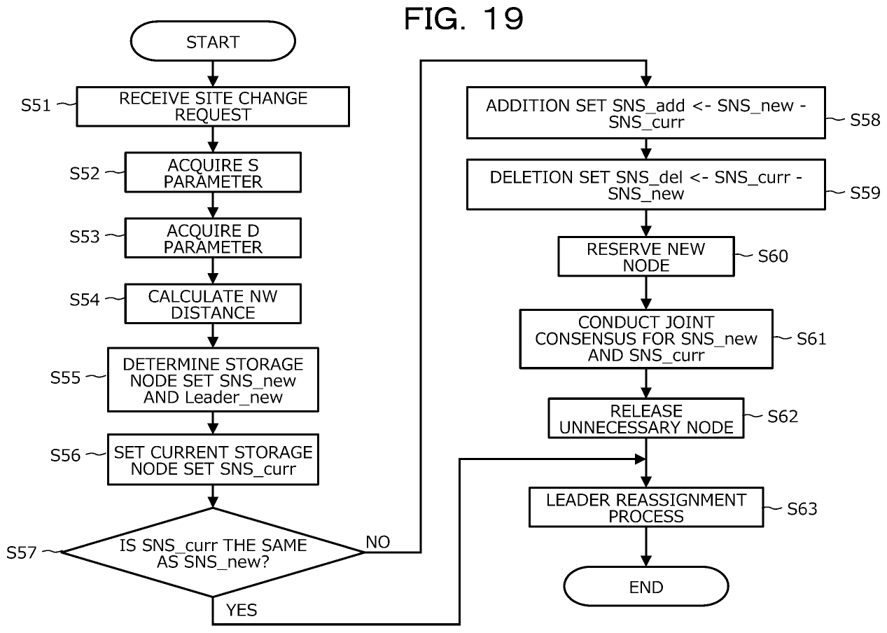

Next, the leader reassignment process by the management apparatus 104 started due to the site change request in the embodiment will be described according to the flowchart (steps S51 to S63) illustrated in FIG. 19.

The management apparatus 104 receives a site change request from any client 103 (step S51).

The management apparatus 104 acquires the S parameters (step S52).

The management apparatus 104 acquires the D parameters (step S53).

The management apparatus 104 calculates the network (NW) distances based on the acquired S and D parameters (step S54).

The management apparatus 104 determines a set SNS_new of storage nodes 101 and a new leader node, Leader_new, based on the calculated network distances (step S55).

The management apparatus 104 sets a current set SNS_Curr of storage nodes 101 (step S56).

The management apparatus 104 determines whether SNS_curr is the same as SNS_new (step S57).

If SNS_curr is the same as SNS_new (see YES route in step S57), the process proceeds to step S63.

If SNS_curr is not the same as SNS_new (see NO route in step S57), the management apparatus 104 sets values of SNS_new-SNS_curr in an addition set SNS_add (step S58).

The management apparatus 104 sets values of SNS_curr-SNS_new in a deletion set SNS_del (step S59).

The management apparatus 104 reserves new nodes based on the values of the addition set SNS_add (step S60).

The management apparatus 104 conducts joint consensus for SNS_curr and SNS_new (step S61).

The management apparatus 104 releases unnecessary nodes based on the values of the deletion set SNS_del (step S62).

The management apparatus 104 executes the leader reassignment process (step S63). The leader reassignment process started due to the site change request is terminated.

### [B] Effects

According to the information processing apparatus 10, the program, and the information processing method in one example of the embodiment described above, for example, the following operation effects may be provided.

The information processing apparatus 10 collects information of accesses executed most by the at least one client 103 via the at least one proxy 102 on a path of each access. Based on the information of accesses, the information processing apparatus 10 calculates the network distances between the plurality of storage nodes 101 and the at least one proxy 102. Based on the network distances, the information processing apparatus 10 determines the leader from the plurality of storage nodes 101, to be the storage node 101 that is close to the proxy 102 accessed most frequently.

This improves the performance of the distributed data store. For example, it is possible to improve the processing speed, throughputs, and latencies at reading and writing by the clients 103.

The information of accesses may include static parameters and dynamic parameters between the plurality of storage nodes 101 and the at least one proxy 102 for calculating the network distances. This allows for precise determination of the leader based on the network distances.

The information processing apparatus 10 may determine the leader when any client 103 determines that an access performance value does not meet a request. The information processing apparatus 10 may determine the leader when any client 103 determines that a request for site change of the plurality of storage nodes 101 is met. This allows determination of the leader to be carried out at appropriate timing.

### [C] Others

The disclosed technique is not limited to the above-described embodiment. The disclosed technique may be carried out by variously modifying the technique without departing from the gist of the present embodiment. Each of the configurations and each of the processes of the present embodiment may be selectively employed or omitted as desired or may be combined with each other as appropriate.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory, the processor being configured to:
in a network coupling a plurality of storage nodes, at least one proxy, and at least one client;
collect information of accesses executed most by the at least one client via the at least one proxy on a path of each access;
based on the information of accesses, calculate network distances between the plurality of storage nodes and the at least one proxy; and
based on the network distances, determine a leader to be one of the plurality of storage nodes that is close to one of the at least one proxy accessed most frequently.

2. The information processing apparatus according to claim 1, wherein
the information of accesses includes static parameters and dynamic parameters between the plurality of storage nodes and the at least one proxy for calculating the network distances.

3. The information processing apparatus according to claim 1, wherein
the processor determines the leader if any of the at least one client determines that an access performance value meets a request.

4. The information processing apparatus according to claim 1, wherein
the processor determines the leader if any of the at least one client determines that a request for site change of the plurality of storage nodes is met.

5. A non-transitory computer-readable recording medium storing a program for causing a computer to execute a process comprising:
in a network coupling a plurality of storage nodes, at least one proxy, and at least one client,
collecting information of accesses executed most by the at least one client via the at least one proxy on a path of each access;
based on the information of accesses, calculating network distances between the plurality of storage nodes and the at least one proxy; and
based on the network distances, determining a leader to be one of the plurality of storage nodes that is close to one of the at least one proxy accessed most frequently.

6. A computer-implemented method comprising:
in a network coupling a plurality of storage nodes, at least one proxy, and at least one client,
collecting information of accesses executed most by the at least one client via the at least one proxy on a path of each access;
based on the information of accesses, calculating network distances between the plurality of storage nodes and the at least one proxy; and
based on the network distances, determining a leader to be one of the plurality of storage nodes that is close to one of the at least one proxy accessed most frequently.
